(19) United States
(12) Patent Application Publication
(10) Pub. No.: US 2016/0117454 A1
(43) Pub. Date: Apr. 28, 2016

(54) AN ONLINE PORTAL FOR ALLOCATING PERSONNEL

(71) Applicant: CURA NOBIS PTE. LTD., Singapore (SG)

(72) Inventor: Christophe Pilloud, St-Prex (CH)

(73) Assignee: CURA NOBIS PTE. LTD., Singapore (SG)

(21) Appl. No.: 14/786,880

(22) PCT Filed: Apr. 23, 2014
(86) PCT No.: PCT/SG2014/000179

§ 371 Date: Oct. 23, 2015

(30) Foreign Application Priority Data
Apr. 23, 2013 (SG) 201303164-6

(51) Int. Cl. G06F 19/00

(52) U.S. Cl. CPC G06F 19/327

(57) ABSTRACT

There is provided an online portal specifically for allocating personnel. The portal includes a criteria matching module hosted on at least one computing device, the criteria matching module being configured for matching at least one personnel to a user's preference; a reservation module hosted on the at least one computing device, the reservation module being configured for the user to reserve at least one personnel provided for selection by the criteria matching module; and a payment module hosted on the at least one computing device, the payment module being configured for retrieving data from both the criteria matching module and the reservation module to determine a cost payable by the user.

### FIELD OF INVENTION

The present invention relates to an online portal for administering to the allocation of personnel at a plurality of locations.

### BACKGROUND

The need for medical care is constantly increasing, especially in developed countries that have an aging population. The allocation of healthcare professionals in an effective and efficient manner is desired. However, none of the existing systems/methods for allocating healthcare professionals is able to provide a platform whereby all requisite steps to provide a care service to healthcare recipients are integrated in a single online package.

Currently, the “front end” of booking (booking interface) is available online, with the “back end” processes (allocation of healthcare professionals) being done manually. In addition, managing the allocation of healthcare professionals external from an institution such as a hospital or clinic generally involves the management of complicated logistical issues.

Generally, organizations managing healthcare professionals have not streamlined their manpower allocation systems in an optimal manner. They are hampered in their optimization efforts either because of financial issues or because these organizations are part of social services/government bodies which manage care sessions internally using pre-determined teams of full time healthcare professionals.

In addition, most of the current allocation systems/methods rely upon turn-based roster systems which may present issues pertaining to disregard of travel time for the healthcare professionals to the desired location, disregard for the expertise/competence of the healthcare professionals for the task at hand, lack of control of the healthcare professionals over their wages, and so forth.

There are clearly shortfalls with regard to the current allocation systems/methods which are in use for healthcare professionals.

Furthermore, it should be appreciated that although only the healthcare industry is mentioned in the preceding paragraphs, generally, systems for managing allocation of personnel in other industries are also flawed.

### SUMMARY

There is provided an online portal specifically for allocating personnel. The portal includes a criteria matching module hosted on at least one computing device, the criteria matching module being configured for matching at least one personnel to a user's preference; a reservation module hosted on the at least one computing device, the reservation module being configured for the user to reserve at least one personnel provided for selection by the criteria matching module; and a payment module hosted on the at least one computing device, the payment module being configured for retrieving data from both the criteria matching module and the reservation module to determine a cost payable by the user.

The online portal further includes a rate calculation module hosted on at least one server, the rate calculation module being configured for determining a first fee payable to the at least one personnel; and a feedback module hosted on at least one server, the feedback module being configured for receiving post session ratings from both the user and the at least one personnel.

Preferably, the criteria matching module is also configured to match the at least one personnel's skills with the user's requirements. Furthermore, the reservation module can also be configured to contact the at least one personnel using at least one communication channel. The payment module is preferably also configured to determine a second fee for a host of the online portal.

It is preferable that the at least one computing device includes a single server.

The payment module can also be configured to make payment to the at least one personnel, whereby payment can be made after both the user and the at least one personnel inputs ratings to the feedback module.

The personnel allocated by the portal is preferably selected from, for example, healthcare professionals, cleaners, bodyguards, sports massage therapists, gardeners, food catering staff and so forth.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows a schematic view of components of an online portal of the present invention.

FIG. 2 shows a landing page for healthcare professionals on the online portal.

FIG. 3 shows a landing page for users on the online portal.

FIG. 4 shows a profile page of a healthcare professional viewable by users.

FIG. 5 shows a profile page of a user viewable by healthcare professionals.

FIG. 6 shows a sample look up table for determining a cost payable by users.

FIG. 7 shows a sample look up table for determining a penalty fee payable by healthcare professionals during various circumstances.

### DESCRIPTION OF PREFERRED EMBODIMENTS

In a preferred embodiment, there is provided an online portal specifically for allocating healthcare professionals to users of the online portal. The portal is also combined with a payment module. The portal enables at least the following:

a) Healthcare recipients (may or may not be the users of the online portal) requiring care sessions having a largest possible selection of healthcare professionals available at desired dates and time;

b) Healthcare professionals' income is increased while maintaining the care sessions at reasonable costs;

c) Healthcare recipients having flexibility with regard to management of the care sessions; and

d) Healthcare professionals having flexibility with regard to management of their work schedules.

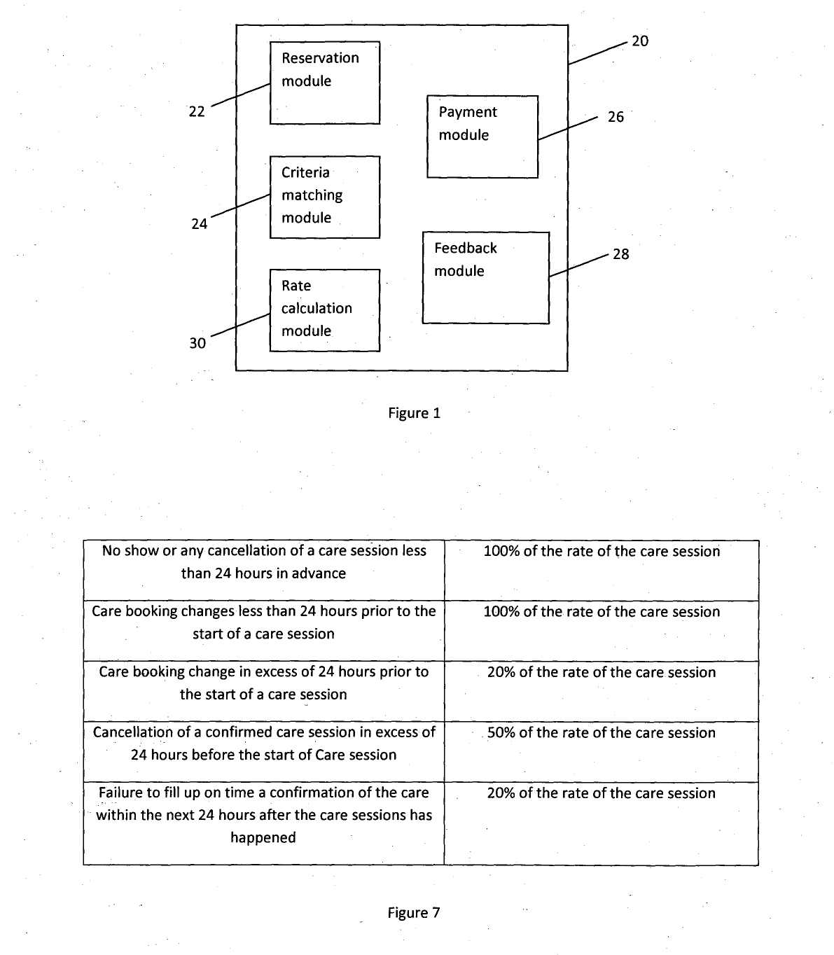

Referring to FIG. 1, there is shown a schematic view of components of the online portal 20 specifically for allocating healthcare professionals. The portal 20 matches care coverage needs of healthcare recipients and the availabilities of healthcare professionals. The components are a reservation module 22, a criteria matching module 24, a payment module 26, a feedback module 28, and a rate calculation module 30. Each of the aforementioned modules 22, 24, 26, 28, 30 is hosted on at least one server, and all the aforementioned modules 22, 24, 26, 28, 30 can be hosted on either a single server (the same server) or multiple servers.

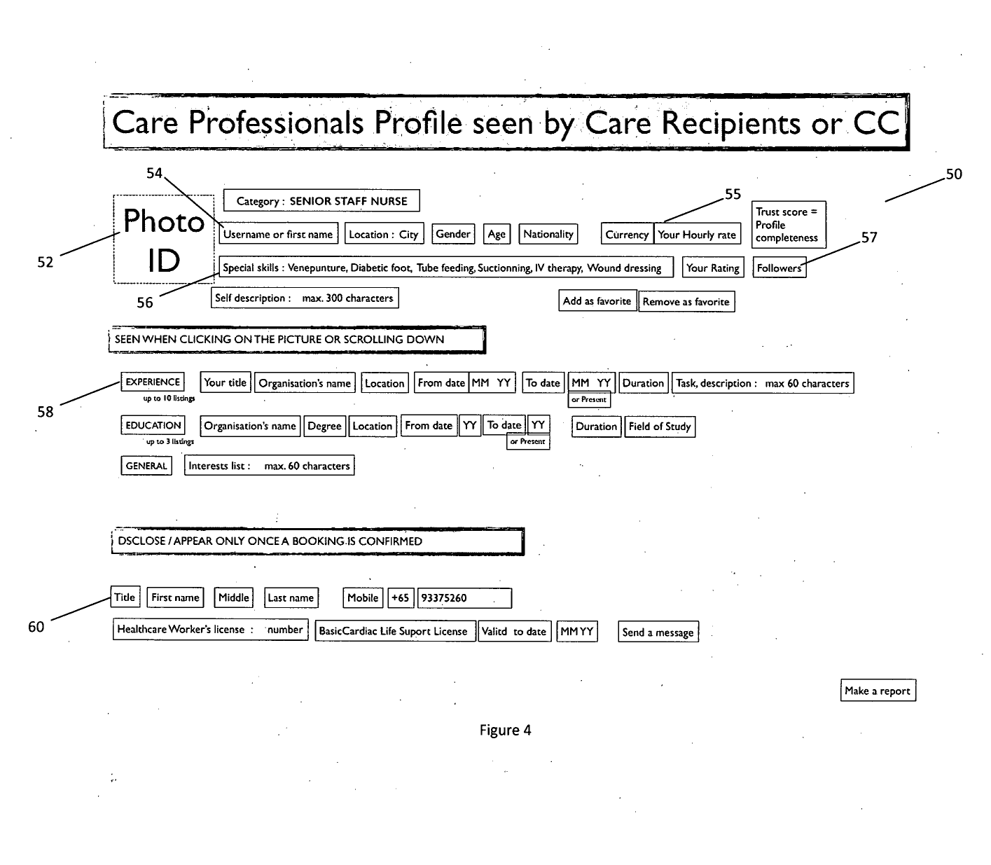

The criteria matching module 24 is configured for matching at least one healthcare professional to a user's preference. FIG. 4 shows a profile page 50 of a healthcare professional viewable by the users when the users wish to obtain more information pertaining to the healthcare professional. It is noted that the users are able to obtain at least the following parameters about the healthcare professional, namely:

appearance 52;

portal ID 54 (may or may not be the healthcare professional's real name);

hourly rate 55;

skill competencies 56;

number of social network followers 57;

level of experience 58; and

contact details 60 (only if the healthcare professional is already engaged for service by the user).

It is appreciated that the profile page 50 allows the users to view competences and care specialties of the healthcare professionals so that the users can make an informed decision with regard to which healthcare professional to choose.

The criteria matching module 24 is able to match the user's preferences with healthcare professionals with parameters that match the user's preferences. In addition, the criteria matching module 24 is also configured to match the at least one healthcare professional's medical skills with the user's medical requirements. For example, healthcare professionals with specific skill competencies and possess more than a pre-defined level of experience are matched with the user's preferences. It should be appreciated that the user can define one or more parameters which is desired from the healthcare professional when signing up to be a member of the portal 20. The desired parameters for the user can be varied during the course of using the portal 20 in accordance to the user's wishes.

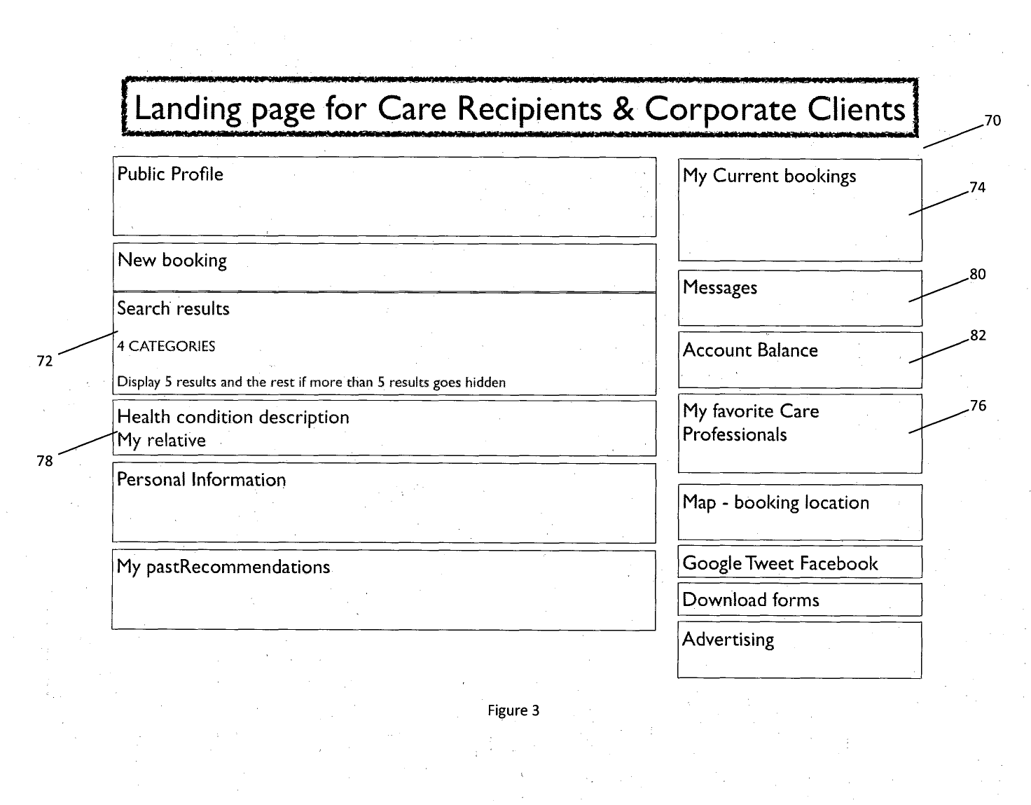

The reservation module 22 enables the user to reserve at least one healthcare professional provided for selection by the criteria matching module 24. The user is able to reserve the at least one healthcare professional from a listing 72 which appears on a landing page for users 70 as shown in FIG. 3. The listing 72 provides the user with a choice of healthcare professionals. The user is able to access the respective profile pages 50 of healthcare professionals in the listing 72 and correspondingly makes a selection. The listing 72 is obtained from the criteria matching module 24 and is populated with at least one healthcare professional matched with the desired parameters defined by the user. The landing page for users 70 provides users with at least some other information such as, for example:

upcoming care session bookings 74;

preferred healthcare professionals 76;

current health conditions/ailments 78;

communications for the user 80; and

account balance 82.

It should be appreciated that the account balance 82 is important as the user has to be aware that there are sufficient funds to cover a total cost of a care session. The care session cannot be booked unless there are sufficient funds shown in the account balance 82 to pay for the care session. This ensures that the care session is pre-paid, and minimises the risk that the healthcare professional is left unpaid after the care session.

The reservation module 22 is also configured to contact the at least one healthcare professional using at least one communication channel, such as, for example, sms, email, instant messaging, instant texting and so forth. Once the care session is booked, the healthcare professional(s) receives a care request via the at least one communication-channel. The request states at least the date and time the healthcare professional(s) is requested to step in and the amount the healthcare professional(s) will be paid. Once accepted by the healthcare professional, the care session is confirmed.

The portal 20 also includes the payment module 26 which is configured to retrieve data from both the criteria matching module 24 and the reservation module 22 to determine a cost payable by the user. The payment module 26 is configured to accept credit cards, and electronic fund transfers. The payment module 26 can also debit and credit accounts. Broadly, the payment module 26 is configured to carry out three steps, namely:

1. Payment is made by the users during the reservation process, prior to the care session.

2. Payment is made to healthcare professionals once the care session has taken place. It should be noted that payment can also be made to healthcare professionals only after both the users and the healthcare professionals have input content to the feedback module 28 (more information will be provided for the feedback module 28 in a later part of the description), as this means that payment can be withheld if there are unresolved issues between the user and the healthcare professional.

3. A commission (consists a percentage of the payment made by users) for a host of the portal 20 is deducted from the payment to healthcare professionals for the specific care session.

The payment module 26 is able to obtain information pertaining to the healthcare professional such as, for example, hourly rate, skill competencies and so forth from the criteria matching module 24. Furthermore, the payment module 26 can also obtain care session details from the reservation module 22 and thus, the payment module 26 is able to process relevant information to determine the cost payable by the user. It should also be appreciated that the healthcare professional is able to define the hourly rate (possibly to ensure relevance and cost competitiveness amongst peers in the same industry) and the payment module 26 is correspondingly able to determine the cost payable by the user.

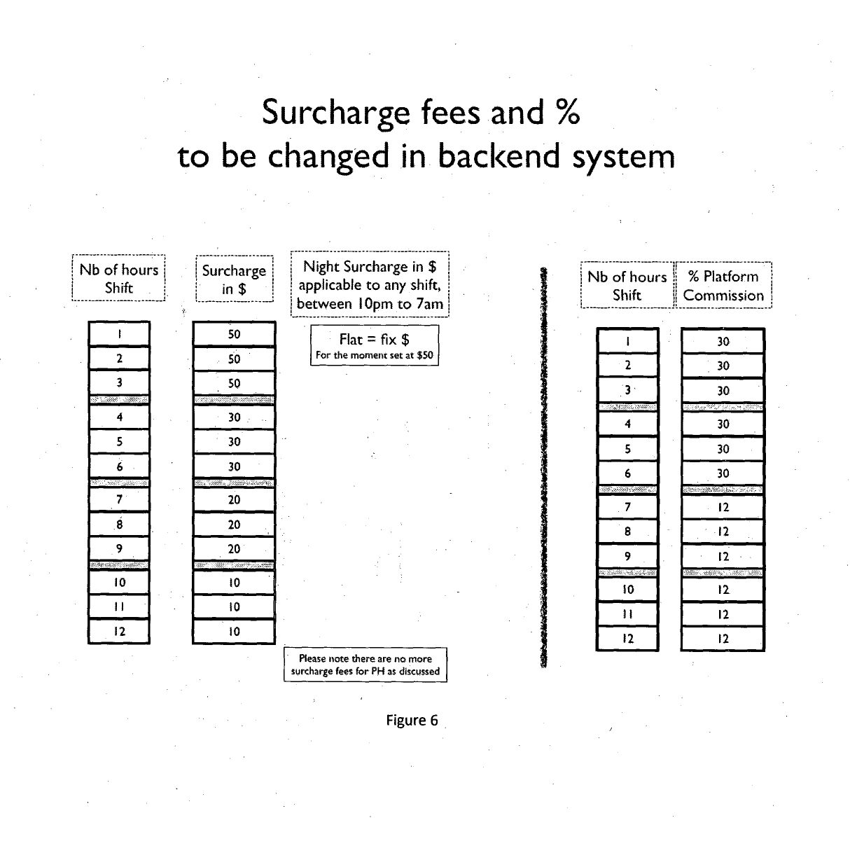

The rate calculation module 30 is configured for determining a fee payable to the at least one healthcare professional. The commission to the host of the portal 20 can vary depending on the length of the care session and other parameters as shown in FIG. 6. The rate calculation module 30 determines the commission in accordance with FIG. 6. With reference to FIG. 6, there is shown how the commission is calculated in accordance to a duration of the care session. Generally, the shorter the care session, the higher the percentage of the payment made by the, users for the commission. Furthermore, there may be a further surcharge incorporated into the payment made by the users, whereby the shorter the care session, the higher the payable surcharge. Such a surcharge minimises an adverse impact on the amount earned by the healthcare professional for short care sessions and instead places a cost burden on the users of the portal 20. Thus, carrying out shorter care sessions is thus no longer disadvantageous for the healthcare professionals. Likewise, a reasonable surcharge does not excessively increase a cost of the care sessions for users which ensures competitive prices. The surcharge can be determined in a manner whereby, that it is adequate to cover transportation costs as well as taxes and other supplementary costs. As shown in FIG. 6, a minimum duration of a care session is one hour while a maximum duration is twelve hours. It should also be appreciated that the numbers in FIG. 6 are merely illustrative, and can be dependent on living standards and cost of living indicators.

Healthcare professionals who are absent from a care session(s) are either not paid or penalized via a penalty fee automatically deducted from their account. The penalty fees are implemented to ensure that the online portal 20 provides reliable service for the users and aims to ensure that every healthcare professional remains committed to their respective booked care sessions. A sample table of the penalty fees is shown in FIG. 7. The payable penalty fees are also determined by the rate calculation module 30. It should be appreciated that the users are also subject to penalty fees if the users are unable to be present for the booked care sessions. This ensures that the interests of the healthcare professionals are also protected.

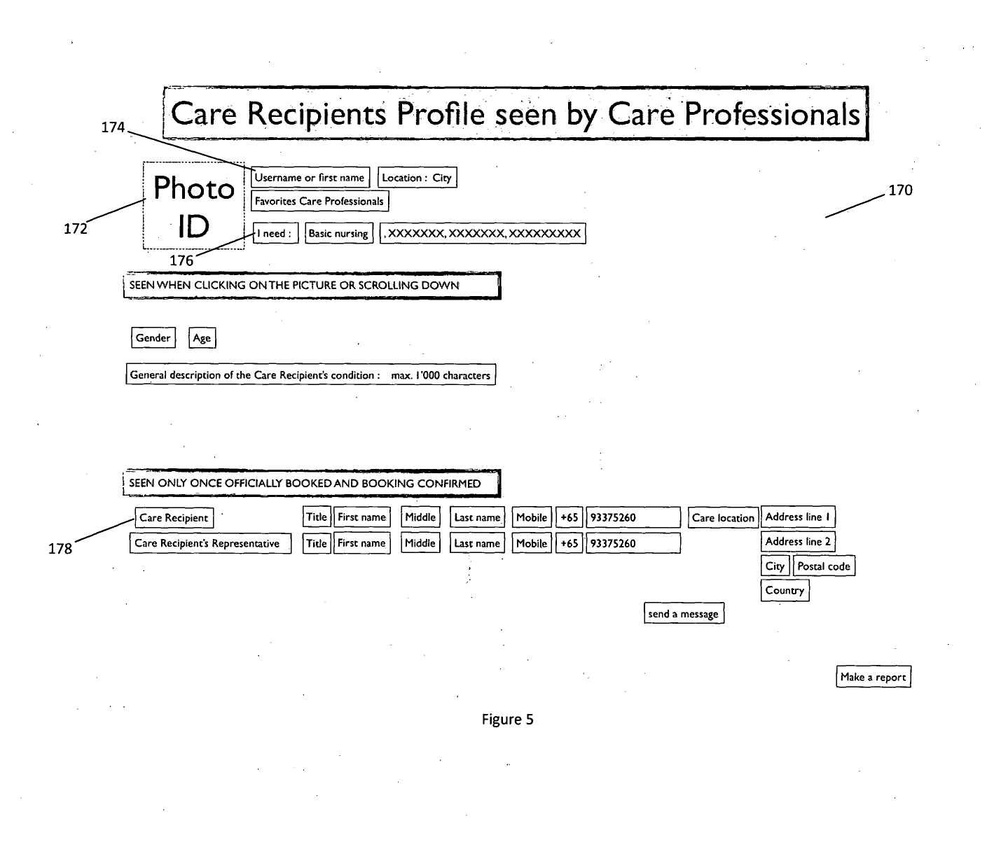

The portal 20 also includes the feedback module 28 configured for receiving post treatment ratings from both the user and the at least one healthcare professional. The feedback module 28 allows both the healthcare professionals and the users to be rated by the other party. The feedback obtained ensures that the interests of both parties are protected concurrently. The input to the feedback module 28 is subsequently associated with profile pages of both parties as shown in FIG. 4 and FIG. 5. The feedback for both parties can be hidden or visible on the profile pages. The healthcare professional's profile page 50 has already been described in earlier paragraphs, and in this example, the feedback is hidden.

Referring to FIG. 5 which shows a profile page 170 of a user of the portal 20 which is viewable by the healthcare professionals, it is noted that the healthcare professionals are able to obtain at least the following parameters about the user, namely:

appearance 172;

portal ID 174;

specific healthcare needs 176; and

contact details 178 (only if the healthcare professional is already engaged for service by the user).

It is appreciated that the profile page 170 allows healthcare professionals to gain an understanding of the user's needs and requirements so that the requisite preparations can be carried out by the healthcare professionals prior to the care session.

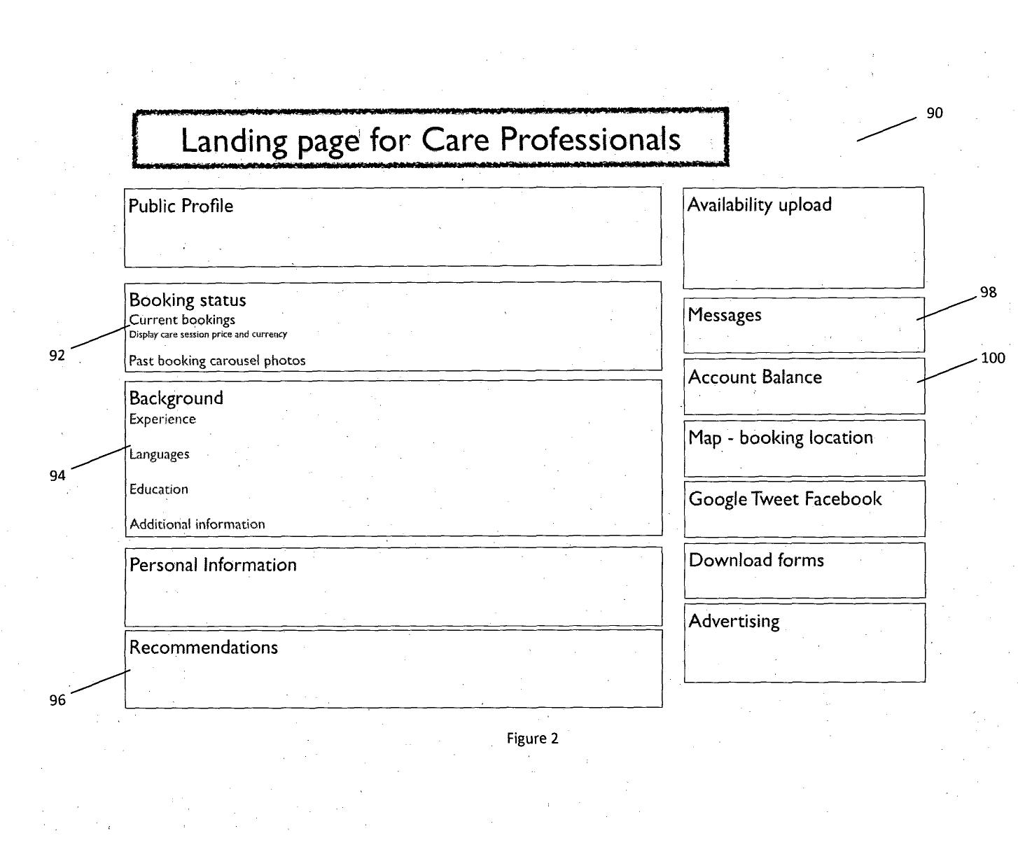

Healthcare professionals who use the portal 20 access the portal 20 via a landing page for healthcare professionals 90 as shown in FIG. 2. The landing page for healthcare professionals 90 provides at least some information such as, for example:

booking status 92;

background 94;

endorsers 96;

communications for the healthcare professional 98; and

account balance 100.

The landing page for healthcare professionals 90 provides the healthcare professional with information regard work schedules.

It should be appreciated that FIGS. 2 to 5 provide screens which allow both the healthcare professionals and the users to interface with the portal 20. Without the screens shown in FIGS. 2 to 5, the functionality of the portal 20 will not be accessible to both the healthcare professionals and the users.

There is also a software application which can be run on smartphones and tablet computers to allow “on-the-go” access to the online portal 20 for both the healthcare recipient and the healthcare professional. The software application optimizes the smaller screen sizes of smartphones and tablet computers compared to the display screens of laptop and desktop computers. The software application is able to help both the users and the healthcare professionals with accessing the functionalities of the portal 20.

It should be appreciated that even though the description only relates to “healthcare professionals”, the invention can also be used for non-certified personnel involved in healthcare/care-giver duties.

Furthermore, it should be noted that even though the preferred embodiment relates to the allocation of healthcare professionals, the portal 20 could also be applicable to other industries whereby personnel can be allocated for paid services. Examples of such personnel include, for example, cleaners, bodyguards, sports massage therapists, gardeners, food catering staff, and so forth.

Whilst there has been described in the foregoing description preferred embodiments of the present invention, it will be understood by those skilled in the technology concerned that many variations or modifications in details of design or construction may be made without departing from the present invention.

1. An online portal specifically for allocating personnel, the portal including:
a criteria matching module hosted on at least one computing device, the criteria matching module being configured for matching at least one personnel to a user's preference;
a reservation module hosted on the at least one computing device, the reservation module being configured for the user to reserve at least one personnel provided for selection by the criteria matching module;
a payment module hosted on the at least one computing device, the payment module being configured for retrieving data from both the criteria matching module and the reservation module to determine a cost payable by the user; and
a feedback module hosted on at least one server, the feedback module being configured for receiving post session ratings from both the user and the at least one personnel;
wherein the payment module is also configured to make payment to the at least one personnel, the payment being made after both the user and the at least one personnel inputs ratings to the feedback module.

2. The online portal of claim 1, further including:
a rate calculation module hosted on at least one server, the rate calculation module being configured for determining a first fee payable to the at least one personnel.

3. The online portal of claim 1, wherein the criteria matching module is also configured to match the at least one personnel's skills with the user's requirements.

4. The online portal of claim 1, wherein the reservation module is also configured to contact the at least one personnel using at least one communication channel.

5. The online portal of claim 1, wherein the payment module is also configured to determine a second fee for a host of the online portal.

6. The online portal of claim 1, wherein the at least one computing device includes a single server.

7. The online portal of claim 1, wherein the personnel is selected from a group consisting of: healthcare professionals, cleaners, bodyguards, sports massage therapists, gardeners, and food catering staff.
